(19) United States
(12) Patent Application Publication
(10) Pub. No.: US 2012/0049632 A1
(43) Pub. Date: Mar. 1, 2012

(54) POWER SUPPLY DEVICE AND RECORDING APPARATUS INCLUDING THE DEVICE

(75) Inventors: Takashi Sato, Tokyo (JP); Katsumi Taguchi, Yokohama-shi (JP)

(73) Assignee: CANON KABUSHIKI KAISHA, Tokyo (JP)

(21) Appl. No.: 13/196,411

(22) Filed: Aug. 2, 2011

(30) Foreign Application Priority Data
Aug. 25, 2010 (JP) 2010-188652

(51) Int. Cl. H02J 1/00

(52) U.S. Cl. 307/80

(57) ABSTRACT

A power supply device which supplies power through a power supply line to a device, the power supply device including a first voltage generation unit which generates first DC voltage and supplies the first DC voltage to the power supply line, a second voltage generation unit which generates second DC voltage that is lower than the first DC voltage and supplies the second DC voltage to the power supply line; and a control unit which stops the power supply by the second voltage to the power supply line and causes the power supply by the first voltage to the power supply line in case where the voltage of the power supply line reaches a predetermined voltage.

### BACKGROUND OF THE INVENTION

1. Field of the Invention

The present invention relates to power supply devices and recording apparatuses including the apparatuses.

2. Description of the Related Art

In an apparatus which drives a device, some technologies may detect the electrical state of the device or the state of the apparatus. Japanese Patent Laid-Open No. 2007-62264 discloses a recording apparatus including a recording head which is a device, in which the presence of a failure of the recording head is determined, and, if some failure is present, the operation by the recording apparatus is stopped and the fact is displayed.

Japanese Patent Laid-Open No. 2007-62264 discloses that a power supply device or power supply device (such as a DC/DC converter) which supplies voltage to a recording head is started to supply voltage to the recording head and check the presence of a failure. However, according to the method, because the check is performed with the same voltage level as that of the operation state on the recording head, the recording head or power supply circuit may possibly fail. In particular, the technology performs a sequence of supplying predetermined voltage by assuming that the DC/DC converter is started at least once and the recording head is normal. If the circuit or power supply line has a malfunction, thermal stress and/or electrical stress may be applied to components within the circuit.

The present invention provides a power supply circuit which safely determines the electrical state of a device or circuit and an apparatus including the circuit.

### SUMMARY OF THE INVENTION

The present invention provides a power supply device and an apparatus including the device.

There is provided a power supply device which supplies power through a power supply line to a device, the power supply device including a first voltage generation unit which generates first DC voltage and supplies the first DC voltage to the power supply line, a second voltage generation unit which generates second DC voltage that is lower than the first DC voltage and supplies the second DC voltage to the power supply line, and a control unit which, if the voltage of the power supply line reaches a predetermined voltage because of the power supply by the second voltage generation unit, stops the power supply from the second voltage generation unit to the power supply line causes power supply from the first voltage generation unit to the power supply line.

Further features of the present invention will become apparent from the following description of exemplary embodiments with reference to the attached drawings.

### BRIEF DESCRIPTION OF THE DRAWINGS

FIG. 1 illustrates a power supply circuit according to a first embodiment.

FIG. 2 is a control flow of power supply according to the first embodiment.

FIG. 3 illustrates a power supply circuit according to a second embodiment.

FIG. 4 is a control flow of power supply according to the second embodiment.

FIGS. 5A to 5C illustrate the states of control signals and generated voltage according to the second embodiment.

FIGS. 6A to 6D are used for explaining charge characteristics of the second embodiment.

FIG. 7 is a perspective view of a recording apparatus according to an embodiment.

FIG. 8 is used for explaining a power supply circuit in the past.

### DESCRIPTION OF THE EMBODIMENTS

### First Embodiment

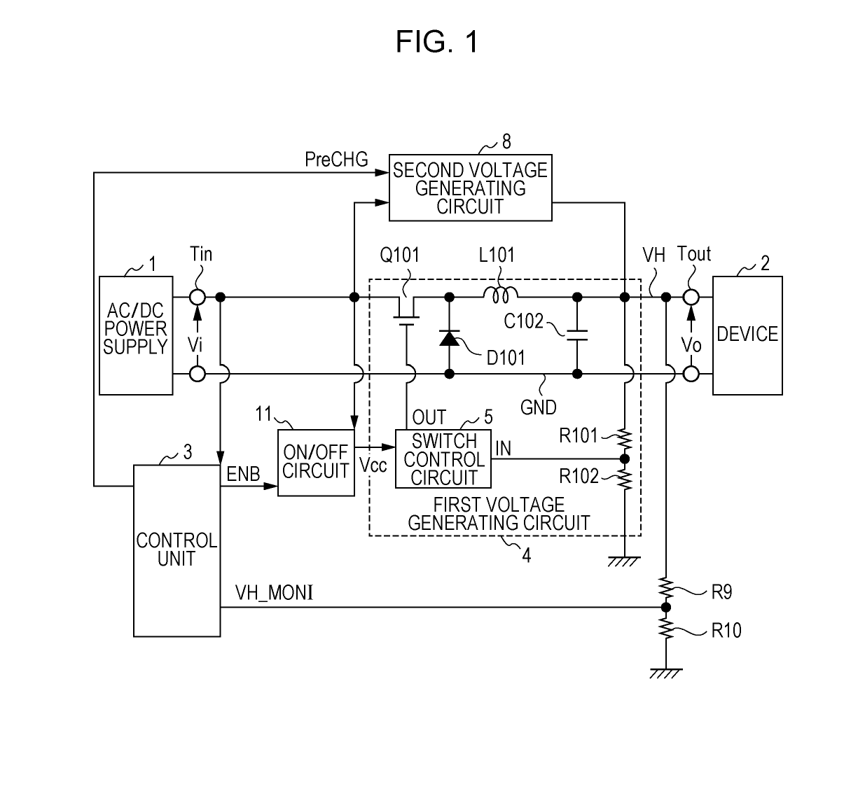

FIG. 1 illustrates a power supply circuit (power supply device) according to a first embodiment. The power supply circuit includes a first voltage generating circuit 4 and a second voltage generating circuit 8. The power supply circuit inputs 32 volt DC(direct-current) voltage Vi to an AC/DC power supply (circuit which converts alternating-current voltage to direct-current voltage) 1 through an input terminal Tin and outputs DC voltage Vout to the device 2 through an output terminal Tout. Power is supplied from the power supply device to the device 2 through a power supply line VH. The term, GND, refers to a ground line. To the power supply line, a capacitor C102 is connected. The capacitor C102 stores charges generated in the power supply circuit.

According to this embodiment, the apparatus is a recording apparatus, and the device 2 is a recording head. A control unit 3 includes an integrated circuit such as an ASIC and a CPU and a memory and controls the apparatus. The control unit 3 has an output port for outputting a control signal, which will be described below, and an input port for inputting a signal. If the apparatus including the power supply circuit is a recording apparatus, the control unit 3 controls the driving of a recording element of the recording head. If the apparatus including the power supply circuit is an image input apparatus, the control unit 3 controls an optical element or sensor including a reading unit.

A first voltage generating circuit 4 includes a PWM control step-down DC/DC converter (circuit which converts direct-current voltage to direct-current voltage). The first voltage generating circuit 4 includes a transistor (switch element) Q101, a diode D101, a coil L101, a capacitor C102, and a switch control circuit 5. The switch control circuit 5 controls constant voltage feedback. The first voltage generating circuit 4 further includes resistances R101 and R102 and inputs voltage divided by the resistances R101 and R102 to the switch control circuit 5. The switch control circuit 5 compares the input voltage and a reference voltage in a comparing circuit and outputs a signal for turning on or off the transistor Q101. The signal may be a signal (PWM signal) which is controlled in pulse width, for example.

The power supply circuit further includes resistances R9 and R10, and the resistances R9 and R10 divides the voltage of the VH. The control unit 3 inputs the divided voltage as a VH_MONI signal. The ON/OFF circuit 11 receives a control signal output from the control unit 3 and controls the supply of logic voltage Vcc to the switch control circuit 5. The control of the supply of logic voltage Vcc may control the start and/or stop of the operations by the switch control circuit 5. The control unit 3 may output a different signal for controlling the start and/or stop of the operations by the switch control circuit 5.

The first voltage generating circuit 4 generates 21 volt voltage from 32 volt voltage supplied from the AC/DC power supply 1. On the basis of the signal output from the switch control circuit (PWM control IC)5, the transistor Q101 is turned on or off.

A second voltage generating circuit 8 generates 14 volt DC voltage on the basis of the voltage input through the input terminal Vi. The 32 volt voltage input through the input terminal Vi is also supplied to the ON/OFF circuit 11 and control unit 3.

The drive voltage (logic voltage, 3.3 volt) is generated from 32 volt voltage by a power supply circuit (not illustrated) provided in the control unit. The logic voltage may be generated and be supplied by a multiple-output AC/DC power supply 1.

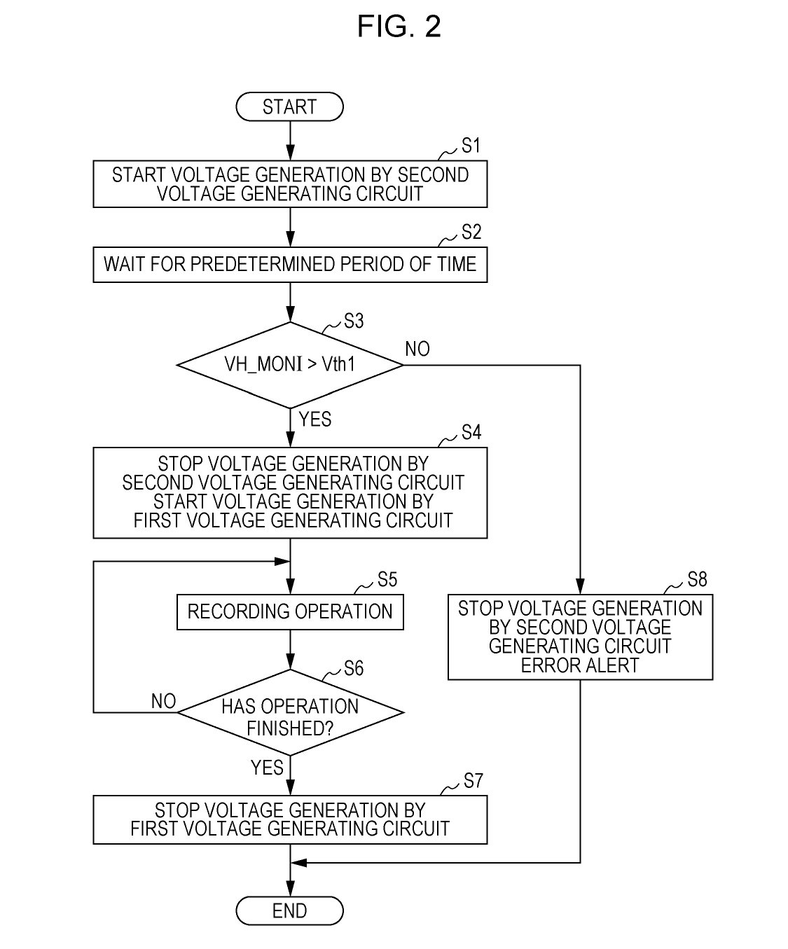

FIG. 2 is a control flow to be performed by the control unit 3. With reference to FIG. 2, the case where a recording apparatus is started from its OFF state will be described. It is assumed here that the potential of the VH_MONI signal upon the start is lower than a threshold voltage Vth 1.

In S1, the control unit 3 outputs a start instruction for voltage generation to the second voltage generating circuit 8. The voltage generation by the second voltage generating circuit 8 is started. The voltage generation by the second voltage generating circuit 8 supplies power to the capacitor C102, and the VH's potential rises up to 14 volt. In S2, processing waists for a predetermined period of time (one second). In S3, whether the VH_MONI's voltage value is higher than the threshold voltage Vth 1 (2.2 volt) or not is determined. If so, the processing moves to S4 where the switch control circuit 5 is started, and the voltage generation by the second voltage generating circuit 8 is stopped. This causes the control unit 3 to output a start instruction for voltage generation to the first voltage generating circuit and output a start instruction for voltage generation (or voltage output) to the second voltage generating circuit 8. The start of the switch control circuit 5 starts the voltage generation by the first voltage generating circuit. The voltage generation by the first voltage generating circuit 4 supplies power to the capacitor C102, and the VH's potential rises up to 21 volt. In S5, the device 2 is driven to perform recording operation. In S6, whether the recording operation is to be finished or not is determined. If so, the switch control circuit 5 is stopped in S7. This stops the voltage generation by the first voltage generating circuit 4.

On the other hand, if not in S3 (VH_MONI's voltage value is lower than the threshold voltage Vth 1), the processing moves to S8. In S8, the voltage generation by the second voltage generating circuit 8 is stopped, or error notification is performed.

In this way, lower voltage than a predetermined voltage is output to the device, and the output voltage is compared with a threshold value Voltage. On the basis of the comparison result, the operation for generating the predetermined voltage is started.

The threshold voltage Vth 1 is defined such that the VH_MONI's voltage value can be higher than the threshold voltage Vth 1 if the device or circuit does not have a failure. If the device or circuit has a failure, the VH_MONI's voltage value is lower than the threshold voltage Vth 1. This control configuration can prevent the supply of high voltage to a failing circuit or device.

The voltage value VH to be supplied from the second voltage generating circuit 8 to the power supply line VH depends on the output voltage by the second voltage generating circuit 8, the internal impedance Z1 of the DC/DC converter 9, and the internal impedance Z2 of the recording head 2.

The internal impedance Z1 of the DC/DC converter 9 is substantially equal to the synthesized resistance value of the serially connected resistance of the resistance R101 and resistance R102 and the serially connected resistance of the resistance R9 and resistance R10.

The internal impedance Z2 of the recording head 2 depends on the value of resistance of a heater included in the recording head 2 and the value of resistance of a switch (transistor) for turning on/off the heater.

### Second Embodiment

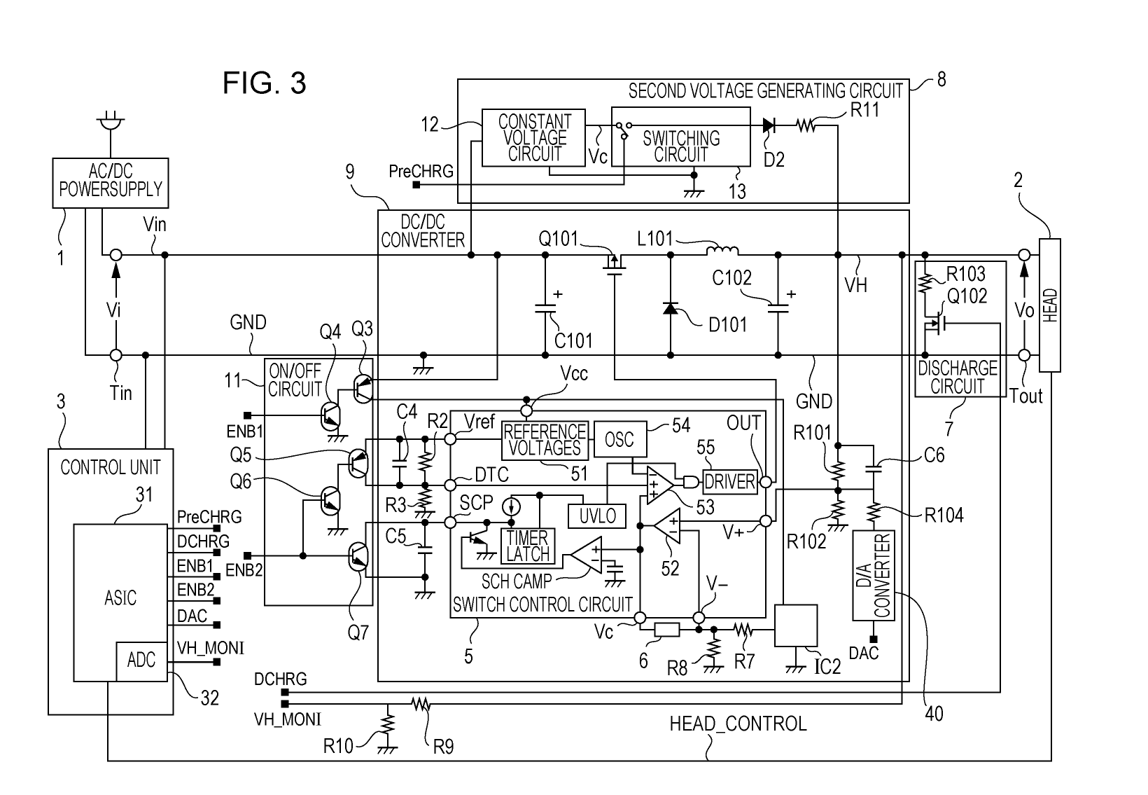

FIG. 3 illustrates a power supply circuit according to a second embodiment. The descriptions on the same details as those in the first embodiment will be omitted, and differences therebetween will be described.

A power supply circuit according to the second embodiment further includes a discharge circuit 7. The discharge circuit 7 functions to drop the voltage to be output to the device 2. The discharge circuit 7 is provided in the output part of the DC/DC converter 9. The discharge circuit 7 is connected to between a power supply line VH and a ground line GND. A DCHRG signal that controls the discharge circuit 7 is output from the control unit 3.

The first voltage generating circuit receives 32 volt voltage supplied from the AC/DC power supply 1 and generates voltage in the range from 17 volt to 24 volt on the basis of the instruction output from the control unit 3. The first voltage generating circuit corresponds to the DC/DC converter 9.

The ON/OFF circuit 11 controls the ON/OFF state of the connection between the input voltage Vi and the power supply terminal Vcc of the switch control circuit 5 and the ON/OFF state of the connection between a Vref terminal and a DTC, and the ON/OFF state of the connection between an SCP terminal and a GND. The ON/OFF circuit 11 receives a signal ENB1 and a signal ENB2 output from the control unit 3. In other words, the ON/OFF circuit 11 controls the voltage to be output to a terminal of the switch control circuit 5. The switch control circuit 5 may be one-chip integrated circuit, for example.

The second voltage generating circuit 8 is connected to the output unit and power supply line VH of the DC/DC converter 9. A PreCHRG signal is a signal which controls an operation by the second voltage generating circuit 8. The PreCHRG signal is output from the control unit 3. The second voltage generating circuit 8 in response to the PreCHRG signal generates 14 volt voltage and supplies it to the output part of the DC/DC converter 9.

Next, the DC/DC converter 9 will be described briefly. The input voltage VHin of the DC/DC converter 9 is input to the switching element Q101 through the capacitor C101. The AC output converted in the switching element Q101 and diode D101 is converted to and output DC voltage through a smoothing circuit including a choke coil L101 and a capacitor C102. The DC voltage is supplied to the recording head 2 through the power supply line VH. The DC/DC converter 9 controls the output voltage in the range from 17 volt to 24 volt on the basis of the signal DAC output from the control unit 3. In order to do so, the DC/DC converter 9 includes a D/A converter 40 which inputs the signal DAC. The D/A converter 40 converts digital data to analog data and outputs the voltage signal corresponding to the analog data.

The voltage output from the smoothing circuit is resistively divided by the resistance R101 and resistance R102, and the divided voltage is input to a non-inverting terminal of an error amplifier 52 within a switch control circuit (PWM control IC) 5. The switch control circuit 5 performs constant voltage feedback control. The reference voltage for the constant voltage feedback control is generated by reference voltage IC 2, and the resistively-divided value by the resistances R7 and R8 is input to an inverting terminal of the error amplifier 52.

The switch control circuit 5 includes circuit blocks such as an internal reference voltage source Vref 51, the error amplifier 52, a PWM comparator 53, a ramp wave generating circuit 54, and an output driver circuit 55. The constant voltage feedback control includes the switch control circuit 5 including the error amplifier 52 and comparator 53, resistances R101 and R102, capacitor C6, and a time constant circuit 6 provided between the input and output of the error amplifier 52. The capacitor C6 and time constant circuit 6 are circuit parts for adjusting the frequency characteristic of the feedback loop.

The discharge circuit 7 includes a MOS-FET Q102 which is a switch element and a resistance R103 for limiting the current of the MOSFET Q102. One side of the MOS-FET Q102 is connected to the ground line GND, and the other is connected to the resistance R103 through the power supply line VH. The control terminal of the MOS-FET Q102 is connected to the control unit. The MOS-FET Q102 is turned on or off in accordance with the DCHRG signal from the control unit 3. If the MOSFET Q102 is turned on and is brought into conduction, the charges stored in the capacitor C102 are fed to the ground line GND, and the voltage of the power supply line VH decreases. In other words, the output voltage Vo decreases. For example, if the DCHRG signal has a “Hi (high)” level, the MOSFET Q102 is brought into conduction. In other words, the MOSFET Q102 becomes on-state. If the DCHRG signal has a “Lo (low)” level, the MOSFET Q102 is shut down. In other words, the MOSFET Q102 becomes off-state.

The second voltage generating circuit 8 includes a constant voltage circuit 12, a switching circuit 13, a diode D2 which is a rectifying device, and a resistance R11 for current control. The constant voltage circuit 12 generates a DC voltage Vc (14 volt) from the input voltage VHin. The switching circuit 13 turns on or off the connection between the output Vc of the constant voltage circuit 12 and the anode terminal of the diode D2 in accordance with the PreCHRG signal. The cathode of the diode D2 is connected to the resistance R11 through the VH voltage line of the DC/DC converter 9.

The ON/OFF circuit 11 includes a plurality of switch elements Q3, Q4, Q5, Q6, and Q7 as illustrated in FIG. 3 and controls the switch control circuit. The switch elements Q3 and Q4 turn on the supply of voltage Vi to the Vcc terminal of the switch control circuit 5 and the reference voltage IC 2 in accordance with the ENB1 signal from the control unit 3.

If a “Hi” level signal (such as 3.3 V) is input for the ENB1 signal, voltage Vi is supplied to the switch control circuit, the reference voltage 51 Vref within the switch control circuit 5 rises, allowing bias application to the input terminals of the switch control circuit. Thus, the switch control circuit 5 starts, and the reference voltage IC 2 also starts. It is assumed here that the Vref voltage of the internal reference voltage 51 is 2.5 V. If a “Lo” level signal (such as 0 V) is input for the ENB1 signal, the input of the voltage Vi to the switch control circuit 5, and reference voltage IC 2 is blocked. The switch elements Q5 and Q6 are turned on/off between the DTC terminal and Vref terminal in accordance with the ENB2 signal from the control unit.

The DTC terminal is an idle period adjusting circuit and is set by voltage division by the resistances R2 and R3 between the Vref terminal and the GND terminal. The potential of the DTC terminal determines the maximum ON duty (proportion of ON) of the PWM signal output by the switch control circuit 5 for ON duty control and is input to a non-inverting terminal of the PWM comparator.

Here, the capacitor C4 is connected in parallel with the resistance R2 between the DTC terminal and the Vref terminal. The resistance R3 is connected between the DTC terminal and the GND. The potential V_{DT} of the DTC terminal having a steady state may be determined by Expression (1).

V_{DT}=Vref×R3/(R3+R2) (1)

For example, when the V_{DT} is equal to or lower than 1.48 V, the duty of the PWM signal is 100%. When the V_{DT} is equal to or higher than 1.97 V, the PWM duty is controlled to 0%. The capacitor C4 connected to the DTC terminal has a soft start function of gradually increasing the duty of the PWM signal at a transient state when the switch control circuit 5 starts and starting by suppressing the input current. The transient voltage VDT(t) upon start of the switch control circuit may be expressed by Expression (2), and the starting time by the soft start may be set.

$$VDT ( t ) = \frac{R 2}{R 3 + R 2} \times Vref + \frac{R 3}{R 3 + R 2} \times Vref \times exp ( - \frac{t}{C 4 \times R} ) \\ {}^{*} 1 R = \frac{R 3 \times R 2}{R 3 + R 2} \qquad ( 2 )$$

If a “Hi” level signal is input for the ENB2 signal, the transistors Q5 and Q6 are brought into conduction. The potential of the DTC terminal of the switch control circuit 5 comes to have the Vref potential, and V_{DT} is held at 2.5 V. Because the potential is higher than the aforementioned 1.97 V, the PWM duty is controlled to 0%. In other words, the OFF time comes to 100%, and the switch element Q101 is shut down.

If a “Lo” level signal is input for the ENB2 signal, the transistors Q5 and Q6 are shut down. The V_{DT} potential comes to have the value set by the expression above, and a PWM control idle period is set. Generally, it is set in the range from the value of the one that is equal to or higher than the duty ratio depending on the ratio (Vo/Vi) between the input voltage Vi and the output voltage Vo to the value of 100%.

Next, a (timer latch) protecting circuit will be described. This function protects the device by coercively shutting off the output when the DC/DC converter 9 fails. When the output voltage decreases, an error amplifier amplifies the error. The output voltage of the error amplifier decreases and attempts to control for a higher switching duty. In other words, the conduction time of the OUT terminal of the switch control circuit 5 is increased. When an SCP (Short Circuit Protection) comparator reduces the output of the error amplifier 52 below the threshold voltage (such as 1.25 V), short-circuit protecting circuit operates through a UVLO circuit. The SCP terminal masks the operation for a predetermined period of time. The time for masking (such as 6.3 ms for 0.01 μF) may be set by an capacitor connected to the SCP terminal. In other words, if the output voltage of the error amplifier keeps being equal to or lower than the threshold voltage for the time set by the SCP terminal or longer, the Driver circuit of the Out terminal is turned off through the low voltage protecting circuit (UVLO) circuit, and PWMCOMP is stopped. The mask function of the SCP terminal is effective for avoiding a malfunction upon start of the DC/DC converter. The time for masking is set in accordance with the time constant of the soft start circuit set by the DTC terminal.

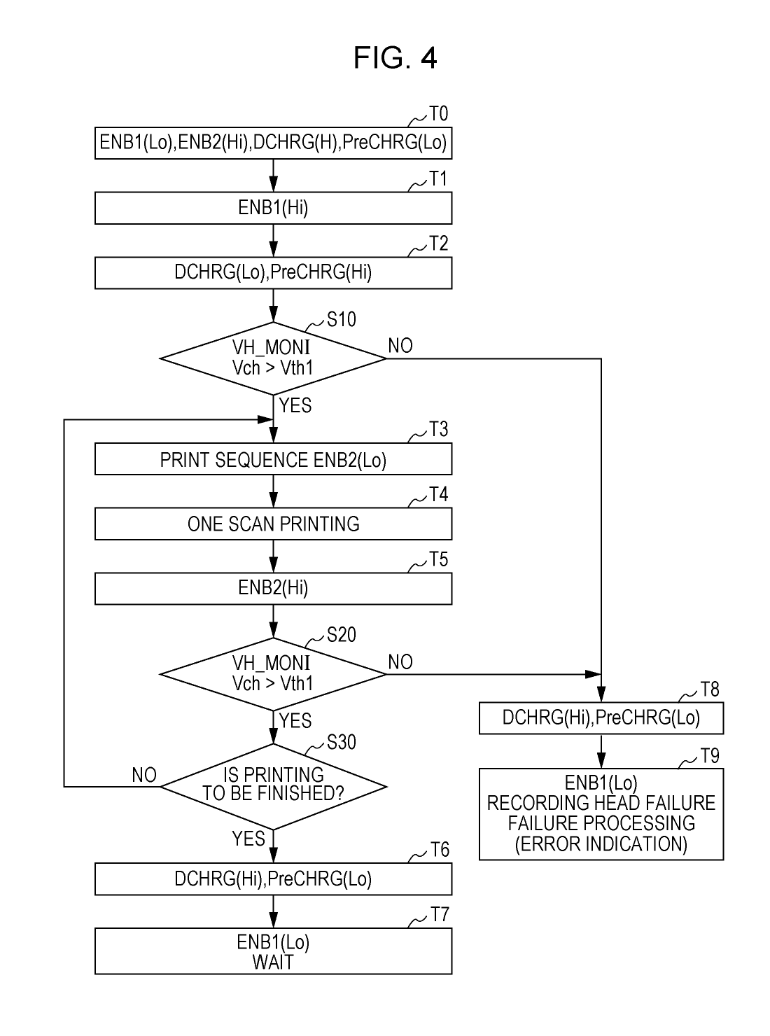

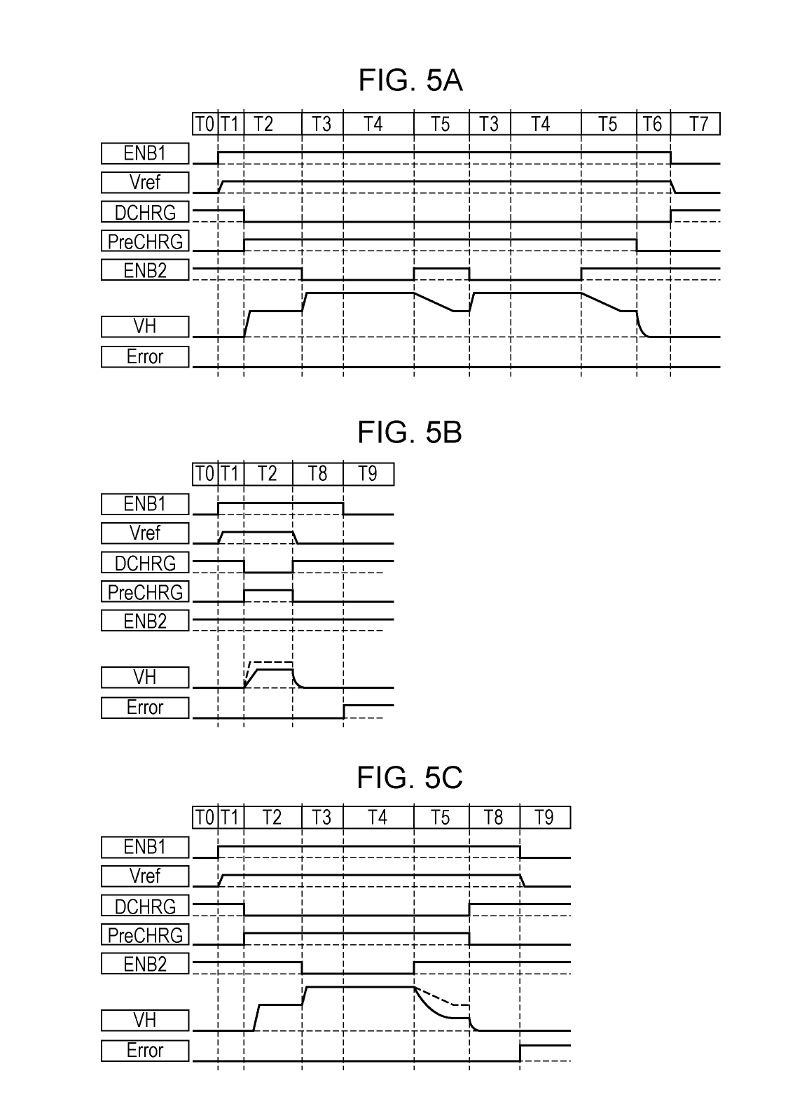

Next, with reference to FIG. 4 and FIGS. 5A to 5C, operations by the power supply circuit will be described. FIG. 4 is a flowchart of an operation in a recording apparatus. FIGS. 5A to 5C illustrates the signal and voltage states of the power supply circuit. FIG. 5A illustrates a state where the recording head 2 is normal. FIG. 5B illustrates a state where the recording head 2 is not normal. FIG. 5C illustrates changes in state of the recording head 2 during a printing operation.

The control unit 3 only changes VH_ENB1 to the “Hi” level from the initial state where the ENB1 and PreCHRG signals have the “Lo” level and the DCHRG signal and ENB2 signal have the “Hi” level (step TO) and starts the PWM control IC 5 (step T1). In the initial state (step T0), because the ENB1 signal has the “Lo” level, voltage Vi is not supplied to the PWM control IC 5 and reference voltage IC 2, the operations by both of them are being stopped. The “Hi” level is input for the ENB2 signal, and the DTC terminal potential is connected to the Vref terminal through the transistor Q5. The SCP terminal potential is grounded through the transistor Q7.

In the second voltage generating circuit 8, the “Lo” level of the PreCHRG signal causes the switching circuit 13 to shut down between the constant voltage circuit 12 and the cathode of the diode D2. In the discharge circuit 7, the “Hi level” of the DCHRG signal brings the MOSFET Q102 into conduction.

Thus, in the initial state (step TO), the operation by the DC/DC converter 9 stops, and the second voltage generating circuit 8 is blocked from the power supply line VH. The MOSFET Q102 in the discharge circuit 7 is in conduction. Therefore, the output voltage Vo of the power supply circuit is held to the zero potential.

Next, steps from the initial state (step T0) to a printing sequence will be described. When the ENB1 signal comes to have the “Hi” level (such as 3.3 V) in the ON/OFF circuit 11, the input voltage Vi is supplied to the switch control circuit 5. When reference voltage circuit 51 within the switch control circuit 5 operates, the reference voltage Vref rises, allowing bias application to another input terminal of the switch control circuit 5. The reference voltage IC 2 also starts, and the resistively-divided value by the resistance R7 and resistance R8 is input to the inverting terminal of the error amplifier of the PWM control IC 5 as a reference voltage (step T1).

Next, the DCHRG signal is changed to have the “Lo” level, and the PreCHRG signal is changed to have the “Hi” level (step T2). The “Lo” level of the DCHRG signal changes the MOSFET Q102 of the discharge circuit 7 from the conduction state to the shut-down state.

When the PreCHRG signal is changed to have the “Hi” level, the switching circuit 13 brings the part between the output Vc of the constant voltage circuit 12 and the anode of the diode D2 into conduction. The output voltage Vc is supplied to the power supply line VH through the diode D2 and resistance R11.

Here, the output voltage Vc of the constant voltage circuit 12 is set to 14 volt which is lower than the output voltage value (17 to 24 volt) of the DC/DC converter 9. The voltage VH′ supplied from the second voltage generating circuit 8 to the power supply line VH exhibits the waveform in FIG. 5A (section T2). For convenience of description, ignoring the forward voltage V_{F} of the diode D2, the parasitic component of the capacitor C102 and so on, the waveform has the characteristic expressed by Expression (3).

$${VH}^{′} = \frac{R 11}{R 11 + Z 12} \times Vc \times ( 1 - exp ( \frac{- t}{C 102 \times Z} ) ) \\ {}^{*} 2 Z 12 = \frac{Z 1 \times Z 2}{Z 1 + Z 2} \\ {}^{*} 3 Z = \frac{Z 12 \times R 11}{Z 12 + R 11} \qquad ( 3 )$$

The voltage value VH′ supplied from the second voltage generating circuit 8 to the power supply line VH depends on the output voltage Vc of the constant voltage circuit 12, the resistance R11, the output capacitor C102, an internal impedance Z1 of the DC/DC converter 9, and an internal impedance Z2 of the recording head 2.

The internal impedance Z1 of the DC/DC converter 9 is substantially equal to the synthesized resistance value of the serially connected resistance of the R101 and resistance R102 and the serially connected resistance of the resistance R9 and resistance R10. The internal impedance Z2 of the recording head 2 depends on the value of resistance of a heater included in the recording head 2 and the value of resistance of a switch (transistor) for turning on/off the heater.

The control unit 3 further includes a VH MON™ terminal for inputting a VH MON™ signal and monitors the potential of the VH_MONI signal in the period for (step T2). The potential of the VH_MONI signal is equal to the value resulting from the resistively division of the voltage Vo by the resistances R9 and R10. In (step T2), the control unit 3 monitors the voltage Vo when the second voltage generating circuit 8 supplies power. The control unit 3 monitors the charging voltage waveform after the PreCHRG signal and DCHRG signal are changed to the “Hi” level and “Lo” level, respectively. A predetermined period of time is determined for the period T2.

In S10, if the potential of the VH_MONI signal is equal to or lower than the preset threshold value Vth 1 (No), it is determined that the state of the recording head 2, the output of the DC/DC converter 9 or the state of the power supply line VH is not proper. The control unit 3 displays an error signal.

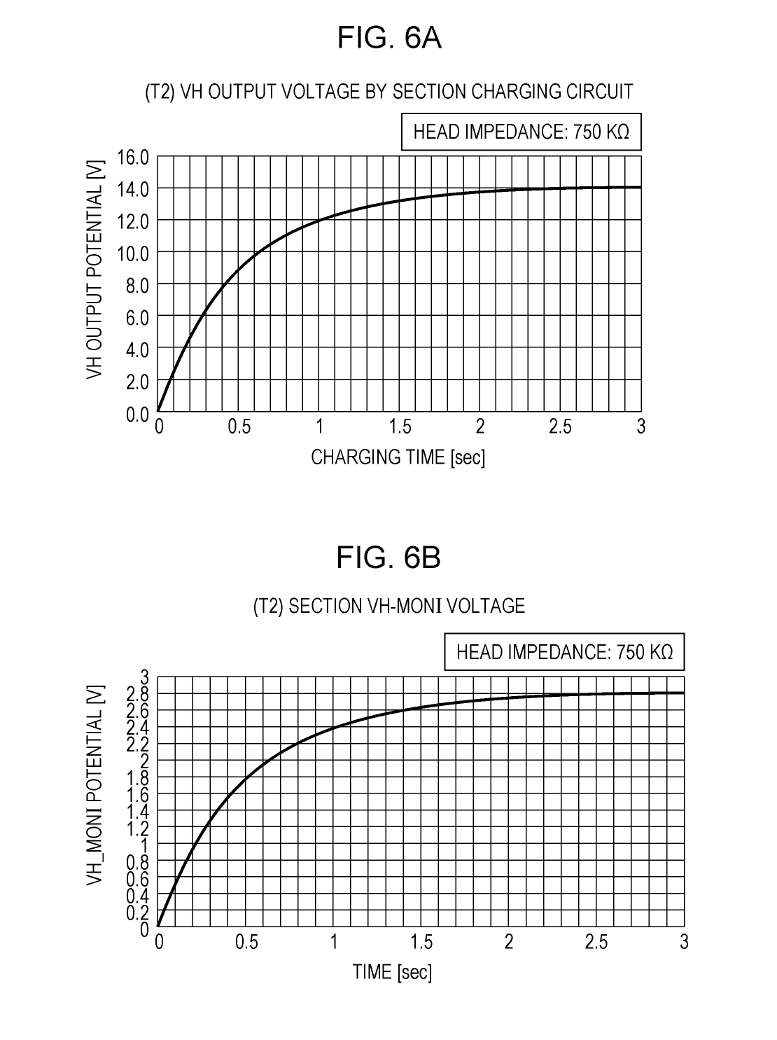

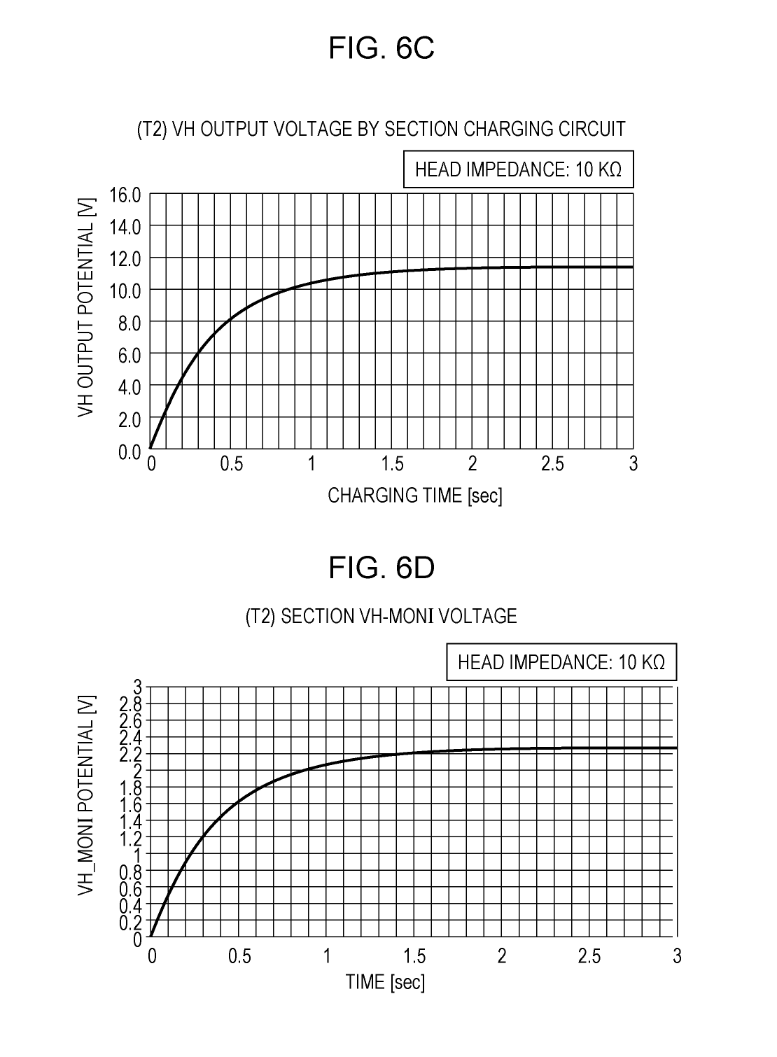

For example, when no failure occurs if the internal impedance Z1 of the DC/DC converter 9 is 30 kΩ, the internal impedance Z2 of the recording head 2 is 750 kΩ, and the resistance R11 is 2.4 kΩ, the potential of the power supply line VH is as in FIG. 6A. Setting the constants of the resistance R9 and resistance R10 in advance such that the potential of the VH_MONI terminal can be about ⅕ of the voltage of the power supply line VH, the voltage as illustrated in FIG. 6B may be detected by the VH_MONI terminal. When the recording head fails and the internal impedance of the recording head is thus 10 kΩ, the VH potential is as illustrated in FIG. 6C. In the same manner, if the internal impedance Z2 of the recording head 2 is 10 kΩ, the potential of the VH_MONI terminal is as illustrated in FIG. 6D.

As illustrated in FIG. 6A to FIG. 6D and expressed by Expression (3), when the recording head 2 or DC/DC converter 9, for example, has some error, the synthesized impedance Z of the internal impedance Z1 of the output of the DC/DC converter 9 and the internal impedance Z2 of the recording head 2 is extremely low. Because the resistive division ratio between the synthesized impedance Z and the resistance R11 of the second voltage generating circuit 8 changes, the value of voltage Vo changes.

Even when the threshold value for determining that the recording head is normal is expected as a range of ±5% of the value in FIG. 6A or FIG. 6B, the change in internal impedance of the recording head may be detected enough.

The VH_MONI signal may be monitored by processing including converting it to a digital signal by an A/D converter (ADC) 32 provided in the ASIC 31 of the control unit 3, for example, and determining the state of the recording head by the ASIC 31 on the basis of the threshold value for determining either normal state or failure state of the recording head. The threshold value may be held in a register provided in the ASIC 31 or a memory (ROM) in the control unit.

In S10, when the value of the potential of the VH_MONI signal in (step T2) is higher than the threshold value Vth 1 (YES), it is determined that the recording head is normal. The processing moves to the next printing sequence (step T3). On the other hand if the potential value of the VH_MONI signal is equal to or lower than the threshold value Vth 1 (NO), it is determined that the internal impedance of the recording head or DC/DC converter 9, for example, has some error. The processing moves to (step T8).

Next, a normal operation (step T3) will be described. In the printing sequence (step T3), if the control unit 3 outputs a “Lo” level ENB2 signal, the transistors Q5, Q6 and Q7 are turned off.

The voltage of the DTC terminal has the state as illustrated in FIG. 5C from Expression (2), the PWM control IC controls so as to gradually increase the duty. The OCP terminal is masked to prevent short-circuit protection by the time PWM control IC set in the section capacitor C5. As a result, the voltage of the power supply line VH increases up to a preset voltage value (higher voltage than Vc).

In this case, the PreCHRG signal may keep the “Hi” level state. In other words, when the DC/DC converter 9 operates, the voltage of the power supply line VH gets higher than the output voltage Vc of the constant voltage circuit 12. However, because the anode of the diode D2 which is a rectifying device is connected on the VH terminal side, Inversely-biased voltage is only applied to the diode D2. Current is not fed from the power supply line VH to the second voltage generating circuit 8.

When the voltage of the power supply line VH reaches 24 volt, the recording head is available for printing. The voltage of the power supply line VH is set in the range of 20 to 24 volt on the basis of a condition such as a temperature of the recording head. The setting may be performed by the ASIC 32 for every printing of one scan. After that, though not illustrated, printing data and a drive signal is output from the control unit to the recording head. The recording is performed on paper (recording medium) on the basis of the printing data (step T4).

If the recording apparatus is a serial inkjet printer, the movement (scan) of the recording head against the recording medium and the transport of the recording medium are performed alternately. Therefore, the printing sequence has a period when the recording head is driven and a period when the recording head is not driven. When the recording head shifts to the period when the recording head is not driven, the ENB2 signal is changed to have the “Hi” level (step T5).

When the ENB2 signal is changed to have the “Hi” level, the transistors Q5, Q6 and Q7 are brought into conduction. Because the transistor Q5 connects the DTC terminal to the Vref voltage, the PWM duty width of the DC/DC converter 9 is coercively held at 0%. Because the transistor Q7 holds the SCP terminal potential at the GND level, the short-circuit protecting circuit is being masked.

In other words, the DC/DC converter 9 have a PWM switching duty of 0%, and the switching operation for switching the switch element Q101 is being stopped. The output voltage of the power supply line VH normally gradually decreases with the synthesized impedance Z of the internal impedance Z1 of the DC/DC converter 9 and the internal impedance Z2 of the recording head 2 and the electrical discharge time constant based on the capacity of the output capacitor C102. The voltage value according to the time passed from the start of the decrease is available in advance. Thus, in (step T5), whether the potential of the power supply line VH is lower than the threshold value Vth 1 or not is monitored. The period T5 is a predetermined time.

In the period for (step T5), the control unit 3 monitors the value resulting from resistive division of voltage Vo by the resistances R9 and R10 after the VH_MONI signal is input. In other words, the control unit 3 monitors the discharge state (voltage level) of the output voltage of the DC/DC converter 9 with the VH_MONI signal.

The voltage Vo decreases up to the voltage value depending on the synthesized impedance Z, the output voltage Vc of the constant voltage circuit 12, and the resistance R11 because the PreCHRG signal has the “Hi” level. Accordingly, in S20, the voltage value of the VH_MONI terminal and the threshold value Vt are compared to determine the presence of a failure. If the voltage value of the VH_MONI terminal is equal to or lower than the threshold value Vth 1, the presence of a failure is determined. On the other hand, if the voltage value of the VH_MONI terminal is higher than the threshold value Vth 1, the normal state is determined.

If no failure is detected in the monitoring of the voltage Vo In S20 (YES), the control unit 3 determines whether the printing is to be finished or not in S30. If printing is to be performed (NO), the processing returns to (step T3). The ENB2 signal is changed to have the “Lo” level, and the DC/DC converter 9 is thus operated. If printing is to be finished (YES), the end of the printing operation is determined. The PreCHRG signal is changed to have the “Lo” level.

This disconnects the switching circuit 13 and the power supply line VH, and the power supply from the constant voltage circuit 12 to the power supply line VH terminates. The DCHRG signal having the “Hi” level brings the MOSFET Q102 of the discharge circuit 7 into conduction. The charges in the capacitor C102 are discharged through the resistance R103, and the output voltage of the DC/DC converter 9 is reduced to the GND level (step T6).

After the voltage of the power supply line VH is reduced to the GND level, the power consumption by the power supply circuit is reduced. Thus, the ENB1 signal is changed to have the “Lo” level, and the supply of voltage Vi to the Vcc terminal of the switch control circuit 5 and reference voltage circuit terminates. This state is a wait state where a printing operation is awaited (step T7).

The case where the VH_MONI terminal potential is equal to or lower than the threshold value Vth 1 as a result of the determination after (step T2) and (step T3) will be described. Before the printing sequence in (step T2), if it is determined that the potential Vch of the VH_MONI terminal is lower than the threshold value Vth 1, the ENB1 signal is set to have the “Lo” level, the DCHRG signal to the “Hi” level and the PreCHRG signal to the “Lo” level (step T8). The setting disconnects between the constant voltage circuit 12 of the second voltage generating circuit 8 and the power supply line VH with the switching circuit 13, and potential of the power supply line VH is reduced to the ground level by the discharge circuit 7. The ENB1 signal is set to have the “Lo” level, and processing for notifying the state to a service man or user is performed (step T9). In (step T9), the ENB1 signal having the “Lo” level stops VHin supply to the switch control circuit 5 and reference voltage IC 2.

The same processing as in (step T8) and (step T9) is performed in the case where the determination processing after (step T5) determines that the VH_MONI terminal potential is equal to or lower than the threshold value Vth 1.

Next, variation examples will be described. A voltage threshold value Vth 2 which is higher than the threshold value Vth 1 may be defined. In S20, the voltage value of the VH_MONI terminal and the threshold value Vth 2 may be compared to determine the presence of a failure. For example, a higher Vth 2 than the Vth 1 may be defined in accordance with the elapsed time from the time when the ENB2 signal is set to have the “Hi” level for a shorter determination time.

As described above, before the DC/DC converter 9 is started, the constant voltage circuit 12 which outputs a lower voltage value than the output voltage value of the DC/DC converter may be used to perform power supply with a predetermined current. During the process, the charge state of the capacitor 102 connecting to the power supply line VH may be checked. Either normal state or failure state may be determined by focusing on a large difference in charge state between the normal state and a failure state. In order to do so, the output voltage value of the DC/DC converter 9 may be monitored by the control unit.

During a recording operation (between one scan recording and another scan recording), the ON/OFF circuit may stop the operation by the DC/DC converter. The output voltage Vc of the constant voltage circuit in the second voltage generating circuit 8 may be set lower than the output voltage of the DC/DC converter 9. Under this condition, the output voltage value of the DC/DC converter 9 may be monitored by the control unit by focusing of a large difference in discharge characteristic (declining characteristic) of the output voltage of the DC/DC converter 9 between the normal state and a failure state. On the basis of the monitored voltage value and the threshold value, the state of the recording head may be determined.

The output of the second voltage generating circuit 8 and the output of the DC/DC converter 9 may be connected through a resistance. This prevents thermal stress and electrical stress in the recording head 2 and/or DC/DC converter 9 even when the internal impedance Z1 of the output part of the DC/DC converter 9 and the internal impedance Z2 of the recording head are changed to an impedance that is close to that of the short-circuit state because the resistance at the output of the second voltage generating circuit 8 controls the leak current.

### [Description on Recording Apparatus]

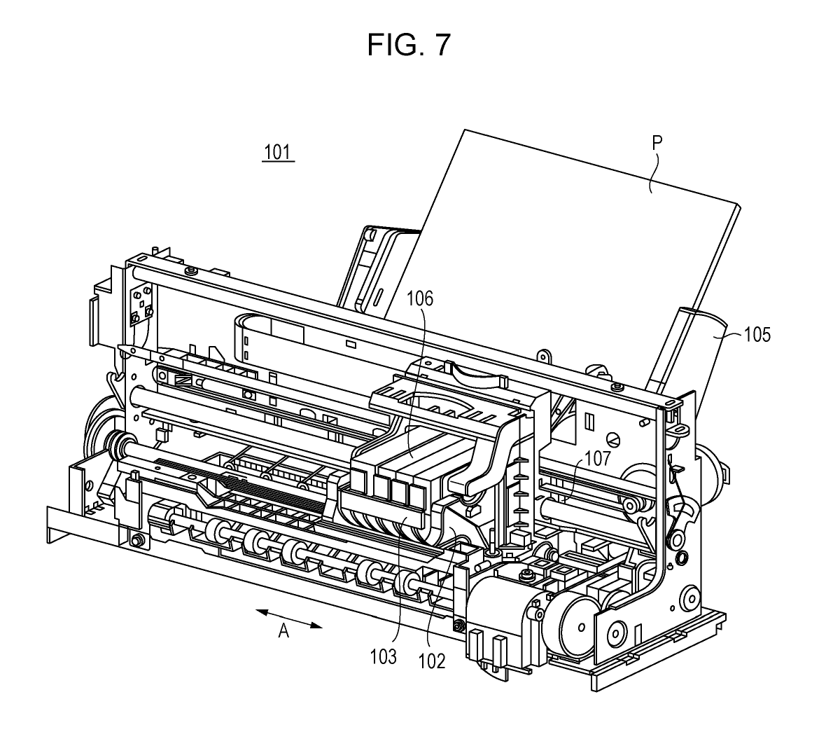

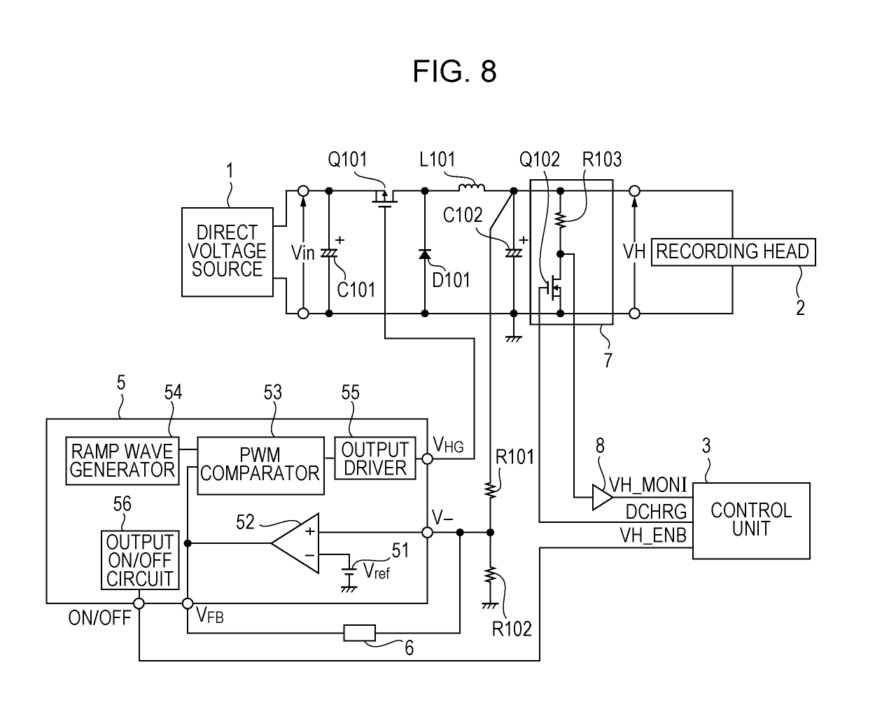

FIG. 7 is a perspective view of the recording apparatus 101 according to the aforementioned embodiment. A recording head 103 which ejects ink is mounted on a carriage 102, and the carriage 102 is moved reciprocately in the arrow A direction for recording. The recording apparatus 101 feeds a recording medium P such as recording paper through a feeding mechanism 105 to a recording position. At the recording position, ink is ejected from the recording head 103 to the recording medium P to record.

The carriage 102 has an ink cartridge 106, for example, in addition to the recording head 103. The ink cartridge 106 stores the ink to be supplied to the recording head 103. The ink cartridge 106 is removably attached to the carriage 102. The carriage 2 has four ink cartridges storing magenta(M), cyan(C), yellow (Y) and black (K) ink. These four ink cartridges may be removed independently.

The recording head 103 has electric thermal conversion members at the ejection ports and applies pulse voltage of the voltage value VH to the electric thermal conversion member corresponding to a record signal. Thus, ink is ejected from the corresponding ejection port.

### Descriptions on Other Embodiments

Having described according to the aforementioned embodiment that the voltage generating circuit includes two kinds of voltage generating circuit, three or more types of voltage generating circuit may be provided. The values of elements to be used in the power supply circuit, generated voltage values, threshold values and so on are not limited to the numerical values above.

According to another circuit configuration, a capacitor may further be connected between the output terminal Tout and a device.

Having described according to the first embodiment that voltage generation (voltage output) by the second voltage generating circuit is stopped in step S4 in FIG. 2, the generation may be continued in step S4, and the voltage output may be stopped in step S7.

According to the second embodiment, the first voltage generating circuit may generate 21 volt voltage.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-188652 filed Aug. 25, 2010, which is hereby incorporated by reference herein in its entirety.

What is claimed is:

1. A power supply device which supplies power through a power supply line to a device, the power supply device comprising:
a first voltage generation unit which generates first DC voltage and supplies the first DC voltage to the power supply line;
a second voltage generation unit which generates second DC voltage that is lower than the first DC voltage and supplies the second DC voltage to the power supply line; and
a control unit which stops the power supply by the second voltage to the power supply line and causes the power supply by the first voltage to the power supply line in case where the voltage of the power supply line reaches a predetermined voltage.

2. The power supply device according to claim 1, further comprising a resistance at an output part of the second voltage generation unit.

3. The power supply device according to claim 2, wherein the predetermined voltage is determined on the basis of the second DC voltage, the internal impedance of the device, and the internal impedance of the first voltage generation unit.

4. The power supply device according to claim 2, wherein the output part further includes a diode, and an anode of the diode is connected to the power supply line.

5. The power supply device according to claim 2, wherein:
the second voltage generation unit further includes a switch which turns on/off the power supply to the power supply line between a constant voltage circuit 2 which generates the second DC voltage and the output part.

6. A recording apparatus including the power supply device according to claim 1, wherein the device is a recording head which ejects ink.
